(19) United States
(12) Patent Application Publication
(10) Pub. No.: US 2004/0265419 A1
(43) Pub. Date: Dec. 30, 2004

(54) Injection molding compounder

(75) Inventor: Walter Wohlrab, Weissenburg (DE)

Correspondence Address: HENRY M FEIEREISEN, LLC, 350 FIFTH AVENUE, SUITE 4714, NEW YORK, NY, 10118, US

(73) Assignee: KRAUSS-MAFFEI KUNSTSTOFFTECHNIK GMBH, Munchen (DE)

(21) Appl. No.: 10/847,203

(22) Filed: May 17, 2004

Related U.S. Application Data
(63) Continuation of application No. PCT/EP02/12462, filed on Nov. 8, 2002.

(30) Foreign Application Priority Data
Nov. 16, 2001 (DE) 101 56 522.4

(51) Int. Cl. B29C 45/54

(52) U.S. Cl. 425/561; 425/587

(57) ABSTRACT

An injection molding compounder includes an extruder with an extruder housing and at least one extruder screw rotatably arranged in the housing, for production of melt, and an injection device is fluidly connectable to the outlet of the extruder. An accumulator for temporarily storing melt is connected to the extruder housing in conveying direction of the extruder at a location upstream of the outlet in an area of the extruder screw so that melt produced in the extruder can be stored in the accumulator.

### CROSS-REFERENCES TO RELATED APPLICATIONS

This application is a continuation of prior filed copending PCT International application no. PCT/EP02/12462, filed Nov. 8, 2002, which designated the United States and on which priority is claimed under 35 U.S.C. §120, the disclosure of which is hereby incorporated by reference.

This application claims the priority of German Patent Application, Serial No. 101 56 522.4, filed Nov. 16, 2001, pursuant to 35 U.S.C. 119(a)-(d), the disclosure of which is incorporated herein by reference.

### BACKGROUND OF THE INVENTION

The present invention relates, in general, to an injection molding compounder.

Extruders are generally used to process various starting materials, of which at least one starting material is a thermoplastic material, to a homogenous melt which is then introduced by an injection device into a mold. The melt is hereby pushed into the cavity at high pressure. Examples for different materials being mixed include thermoplastic polymers or so-called thermosetting polymers with organic or inorganic particles or fiber-shaped fill elements and ceramics with wax or polymer binders.

The combination of an extruder and an injection device connected downstream in flow direction is typically designated as injection molding compounder. International publication no. WO 86/06321 discloses, for example, an injection molding compounder with a twin-screw extruder for producing melt which is then transferred into a plunger-type injection unit. As the plunger is pushed forwards, melt contained in the chamber of the injection device is introduced into the cavity of the molding tool. During return travel of the plunger, a non-return valve clears the path for the melt forwards so that a sufficient shot amount can again be provided in front of the plunger. A drawback of an injection molding compounder of this type resides in the fact that the extruder can only be operated discontinuously and thus has to be shut down during each injection process.

U.S. Pat. No. 6,071,461, or German Pat. No. DE 11 42 229 as well as JP utility model 36-19372 describe the provision of a quasi-continuous operation with a continuously running extruder and intermittently running injection device, by providing an accumulator (also called buffer) in which melt material continuously produced by the extruder is temporarily stored during an injection process. When the injection device is cleared again for filling with melt, melt material is introduced into the injection device from the extruder as well as from the accumulator. The proposed accumulator of these conventional injection molding compounders is, however, complicated in structure and requires feed lines and discharge lines to and from the accumulator.

It would therefore be desirable and advantageous to provide an improved injection molding compounder which obviates prior art shortcomings and which is simple in construction and cost-efficient while yet being reliable in operation.

### SUMMARY OF THE INVENTION

According to one aspect of the present invention, an injection molding compounder includes an extruder having an extruder housing and at least one extruder screw rotatably disposed in an interior space of the extruder housing for producing melt and transporting melt to an outlet, an injection device fluidly connectable to the outlet of the extruder, and an accumulator fluidly connectable to the interior space of the extruder for receiving and discharging melt, with the accumulator positioned in melt transport direction at a location upstream of the outlet in an area of the extruder screw.

As a consequence of this construction, melt produced in the extruder flows in one mode of operation into the accumulator before reaching the outlet of the extruder, and exits the accumulator again in another mode of operation for introduction into the extruder. The hereby provided opening of the extruder housing, through which opening the outflow or inflow of melt from or into the accumulator takes place, is thus located, as viewed in axial direction of the extruder, in the area of the at least one extruder screw. This is accompanied by many advantages. Melt can be supplied directly to the injection device, after exiting the extruder, without requiring a separate bypass to the accumulator. Moreover, melt temporarily stored in the accumulator is mixed again during outflow from the accumulator with melt located in the extruder. For this purpose, mixing elements may suitably be provided in the extruder, in particular at the extruder screws. These mixing elements may be provided in the area of the outflow or inflow opening, as well as downstream thereof. Overall, the present invention thus provides a continuously operated extruder whose melt production can be withdrawn in batches.

A further advantage in connection with highly viscous melt material resides in the fact that the end of the extruder assists with its conveying action the transport of the melt and the introduction into the injection device.

According to another feature of the present invention, the accumulator may be constructed integral with the extruder. Suitably, the accumulator may be flange-mounted directly to the extruder housing. As a result, the injection molding compounder according to the invention is especially compact, and separate lines and therefore costs can be saved.

According to another feature of the present invention, the accumulator may include a housing, for example in cylindrical shape, and a plunger movably guided in the housing for formation of a reservoir with variable volume. The plunger may be acted upon in the direction of the at least one extruder screw for back and/or forth movement relative thereto. In this case, a controlled outflow or inflow of melt in the accumulator is possible. Of course, respective spring devices, hydraulic devices, pneumatic devices, electromotive or mechanical devices are hereby be provided for operation of the plunger, as well as respective control and regulating devices.

According to another feature of the present invention, the plunger has a screw-proximal part which may be shaped complementary to the screw geometry so that the contour of the extruder housing, in particular the extruder barrel, is replicated, when the plunger is fully shifted inwardly and the reservoir approaches essentially zero, when the plunger moves toward a screw-proximal end position. In other words, the accumulator can be completely emptied and no residue is left behind in the accumulator. Suitably, the plunger has an end surface which extends flush with an inner wall of the extruder housing, when the plunger reaches the screw-proximal end position.

The extruder may be equipped with one, two or more screws. Especially suitable are twin-screw extruders with screws that run in a same direction or in opposite direction.

### BRIEF DESCRIPTION OF THE DRAWING

Other features and advantages of the present invention will be more readily apparent upon reading the following description of currently preferred exemplified embodiments of the invention with reference to the accompanying drawing, in which:

FIG. 1 is a schematic illustration of an injection molding compounder according to the present invention with injection device and extruder including integrated accumulator, and

FIG. 2 is a sectional view of the injection molding compounder taken along the line II-II in FIG. 1.

### DETAILED DESCRIPTION OF PREFERRED EMBODIMENTS

Throughout all the Figures, same or corresponding elements are generally indicated by same reference numerals. These depicted embodiments are to be understood as illustrative of the invention and not as limiting in any way. It should also be understood that the drawings are not necessarily to scale and that the embodiments are sometimes illustrated by graphic symbols, phantom lines, diagrammatic representations and fragmentary views. In certain instances, details which are not necessary for an understanding of the present invention or which render other details difficult to perceive may have been omitted.

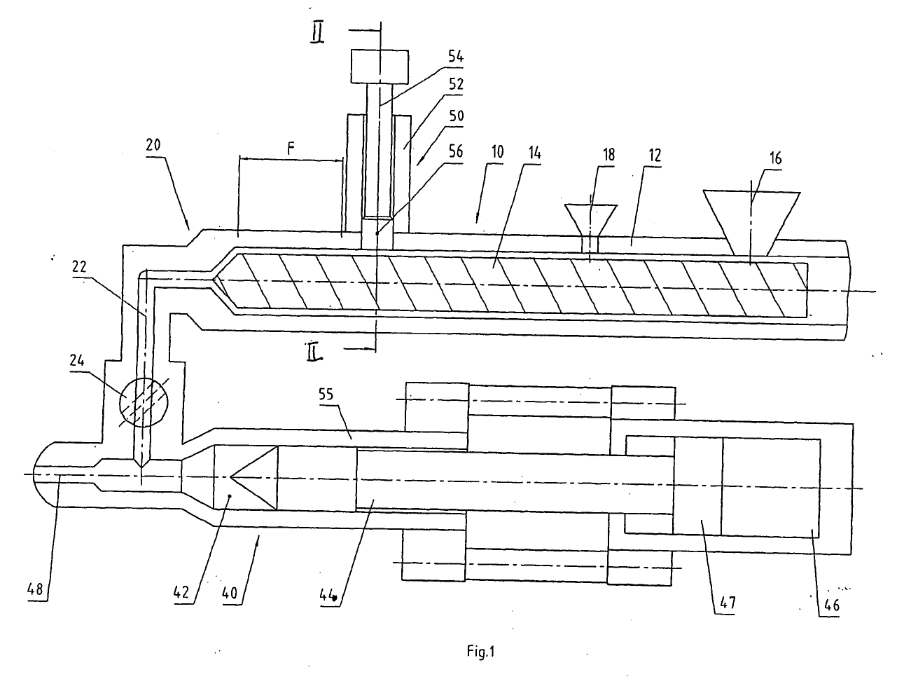

Turning now to the drawing, and in particular to FIG. 1, there is shown a schematic illustration of an injection molding compounder according to the present invention, including an extruder 10 having an extruder housing 12 in the form of an extruder barrel. Rotatably disposed in the extruder housing 12 are two extruder screws 14 rotating in a same direction. Of course, the extruder screws may also operate in opposite direction. A drive for the extruder screws 14 is not illustrated here for the sake of simplicity, as the structure of such a drive is generally known and does not form part of the present invention.

The extruder housing 12 includes two fill openings, namely a first feed hopper 16 and a second feed hopper 18. Various materials can be introduced via the feed hoppers into the extruder 10. It is, for example, possible to introduce polypropylene pellets via the first feed hopper 16 into the extruder 10 and to add glass fiber material via the second feed hopper 18.

During operation of the extruder screws 14, melt with added glass fiber is produced in the extruder 10. The outlet of the extruder 10 is connected in a manner known per se via a connecting line 22 with the forward part of an injection device 40. The connecting line 22 terminates hereby in the forward part of an injection chamber 42 of the injection device 40. In order to be able to de-couple the injection device 40 from the extruder 10, a valve 24 is provided in the connecting line 22 for cutting the flow communication.

The injection device 40, also called shot-pot, is of conventional design and includes essentially an injection plunger 44 which can move back and forth in an injection cylinder 55. The injection plunger 44 is acted upon by a hydraulic device, not shown in more detail, which operates a hydraulic plunger 47 in a hydraulic chamber 46 for back and forth movement of the injection plunger 44.

The mode of operation of the injection device 40 is as follows: When the valve 24 is open, melt is filled into the injection chamber 42 while the plunger 44 retracts or is pushed back. Once the injection chamber 42 is filled in the desired manner, valve 24 is closed, and melt is introduced via an injection nozzle into a cavity of a molding tool (not shown) as the plunger 44 moves forward.

An essential component of the injection molding compounder according to the invention is the provision of an accumulator 50 for the melt, which has a cylindrical housing 52 directly flange-mounted to the extruder housing 12. Supported for reciprocation in the cylindrical housing 52 is a plunger 54 which extends perpendicular to the conveying direction of the extruder 10. The back-and-forth movement of the plunger 54 creates a reservoir with variable volume. The interior space of the extruder 10 is in fluid communication with this reservoir, here via a bore with constant diameter.

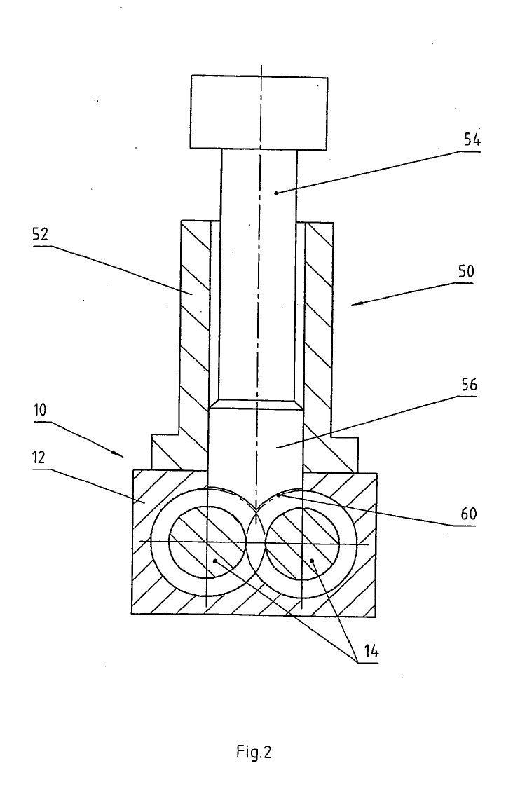

The plunger 54 has on the extruder screw side an end 56 which, as shown in more detail in FIG. 2, is configured in accordance with the inner contour of the extruder barrel 12. In this way, the reservoir can be brought to zero, when the plunger 54 is shifted completely inwards, so that no melt residues can remain in this situation in the accumulator 50.

Although not shown in detail, the plunger 52 can be biased for movement in a direction to or away from the extruder screws 14. Spring elements, pneumatic, hydraulic or electromagnetic devices may be used for example here. A suitably controlled or regulated operation of the plunger 54 allows a precise inflow or outflow of melt from or into the accumulator 50. The plunger 54 is thus biased by a force in a direction toward the extruder screw 14, when melt is desired to flow out from the accumulator 50 back into the extruder 10.

The mode of operation of the injection molding compounder according to the invention is as follows: When the valve 24 is open and melt should be introduced into the injection device 40, melt is directly conducted from the extruder 10 via the connecting line 22 into the injection chamber 42 of the injection device 40.

When the injection chamber 42 is sufficiently filled and the valve 24 is closed for an injection process, melt is pushed into the accumulator 50 during continuous operation of the extruder screws 14 and resultant continuous production of melt, so that the plunger 54 is shifted upwards in the illustration of FIGS. 1 and 2. Further melt advancement does no longer take place in the area (F) of the extruder 10. Rather, melt located in this area remains in this area.

Melt is fed into the accumulator 50 as long as the valve 24 is closed. Of course, the volume of the accumulator 50 should be dimensioned in such a way that accumulating melt during closed valve 24 can be received completely in the accumulator 50 which acts as a buffer.

When the valve 24 opens after an injection process to allow re-charging of the injection device 40, the plunger 54 moves inwardly to force melt in the accumulator 50 back again into the interior space of the extruder 10. The extruder screws 14 are hereby suitably configured to mix the melt incoming form the accumulator 50 with the melt in the upstream part of the extruder 10.

During charging of the injection device 40, the reservoir of the accumulator 50 is completely emptied. As a consequence of the configuration of the inner plunger surface 56, as shown in particular in FIG. 2, it is assured that all melt in the reservoir is returned completely into the extruder 10 so that no melt residues are left in the accumulator 50.

The screw section F may further be configured to promote a better conveying action so that highly viscous melt in particular can easily be supplied via the connecting line 22 to the injection device 40.

The present invention provides a cost-efficient, compact and simple injection molding compounder which permits a discharge in batches, even when the screw operates continuously.

While the invention has been illustrated and described in connection with currently preferred embodiments shown and described in detail, it is not intended to be limited to the details shown since various modifications and structural changes may be made without departing in any way from the spirit of the present invention. The embodiments were chosen and described in order to best explain the principles of the invention and practical application to thereby enable a person skilled in the art to best utilize the invention and various embodiments with various modifications as are suited to the particular use contemplated.

What is claimed as new and desired to be protected by Letters Patent is set forth in the appended claims and includes equivalents of the elements recited therein:

What is claimed is:

1. An injection molding compounder, comprising:
an extruder having an extruder housing and at least one extruder screw rotatably disposed in an interior space of the extruder housing for producing melt and transporting melt to an outlet;
an injection device fluidly connectable to the outlet of the extruder; and
an accumulator fluidly connectable to the interior space of the extruder for receiving and discharging melt, said accumulator positioned in melt transport direction at a location upstream of the outlet in an area of the extruder screw.

2. The injection molding compounder of claim 1, wherein the accumulator is constructed integral with the extruder.

3. The injection molding compounder of claim 1, wherein the accumulator is flange-mounted directly to the extruder housing.

4. The injection molding compounder of claim 1, wherein the accumulator includes a housing and a plunger movably guided in the housing for formation of a reservoir with variable volume.

5. The injection molding compounder of claim 4, wherein the plunger is acted upon in the direction of the at least one extruder screw for back and/or forth movement relative thereto.

6. The injection molding compounder of claim 5, and further comprising a biasing device for urging the plunger in a direction toward the at least one extruder screw.

7. The injection molding compounder of claim 6, wherein the biasing device is a member selected from the group consisting of spring, hydraulic device, pneumatic device, electromotive device and mechanical device.

8. The injection molding compounder of claim 4, wherein the plunger has a screw-proximal part which is so shaped that the reservoir approaches essentially zero, when the plunger moves toward a screw-proximal end position.

9. The injection molding compounder of claim 4, wherein the plunger has a screw-proximal end surface which extends an inner wall of the extruder housing, when the plunger reaches a screw-proximal end position.

10. The injection molding compounder of claim 1, wherein the at least one extruder screw has mixing elements in an area of the accumulator.

11. The injection molding compounder of claim 1, wherein the extruder has a further of said extruder screw, said extruder screws operating in a same direction.

12. The injection molding compounder of claim 1, wherein the extruder has a further of said extruder screw, said extruder screws operating in opposite direction.
